(19) United States
(12) Patent Application Publication
(10) Pub. No.: US 2012/0290321 A1
(43) Pub. Date: Nov. 15, 2012

(54) Computer implemented compensation for medical services

(76) Inventors: Christoph Hachmöller, Jena (DE); Karsten Hiltawsky, Schwerte (DE); Sebastian Schmidt, Weisendorf (DE); Sabine Schäffer-Kundler, Herzogenaurach (DE)

(21) Appl. No.: 13/325,406

(22) Filed: Dec. 14, 2011

Related U.S. Application Data
(60) Provisional application No. 61/484,276, filed on May 10, 2011.

(51) Int. Cl. G06Q 50/24

(52) U.S. Cl. 705/3

(57) ABSTRACT

A computer implemented method and system for compensating costs for medical services are provided. The system has at least three actors, a compensation unit, a referring computer and a service computer for executing the medical service ordered by the referring computer. After receiving a medical report as result of the medical services rendered, the referring computer is an evaluation unit for accessing quality of the medical service. Evaluation data are transmitted to the compensation unit for computation of compensation for the medical service taken into account the evaluation data for accessing quality of the medical service.

### CROSS REFERENCE TO RELATED APPLICATIONS

The present application claims the benefit of a provisional patent application filed on May 10, 2011, and assigned application No. 61/484,276, which is incorporated by reference herein in its entirety.

### FIELD OF THE INVENTION

The present invention generally relates to a computer implemented technique for compensating medical services, which are executed by means of a service computer of an (external) service partner and which are ordered by a referring computer of a referring physician. A compensation unit is adapted for calculation of compensation for medical services rendered in connection with a specific patient, wherein all actors (a compensation unit, the referring computer of a referring physician and the service computer of the service partner) interact and communicate via a computer network.

### BACKGROUND OF THE INVENTION

During medical healthcare of a patient, normally, one (specific) physician services and cares for the patient. This applies to ambulant care as well as to in-patient or non-ambulatory medication. The attending doctor usually has the possibility to order diagnostic or therapeutic or other medical procedures. Those procedures might be carried out by external or other departments or sections within a clinical institution. In case the medical procedure is not carried out by the attending doctor, the attending doctor is named referring physician and orders for example a specific examination as an additional medical service and refers the patient to this department or clinical division. For example a surgeon might refer a patient to the radiological department of the clinic, for receiving a radiogram of the patient's hip, in case the patient sees the surgeon for suffering pain in his hip.

Because of the specialization with respect to medical services, typically specific medical services are referred to specific service partners for executing the ordered services. Up to now in the state of the art systems the referring physician has no opportunity to evaluate the result of the medical service rendered with regard to compensation. Another drawback of the state of the art systems is that it is not possible to make an assessment of quality relating to the medical service rendered for the purpose of compensation. Further, there is no opportunity to evaluate the completeness of the ordered service during compensation.

### SUMMARY OF INVENTION

Based on the above-mentioned drawbacks of the state of the art systems there is a need for an improved computer implemented mechanism for compensation for medical services taking into account an evaluation of the result of the medical service rendered. Further, it is desirable to provide a computer implemented platform and system in order to provide data relevant for compensation automatically and to combine accounting for medical services with an evaluation of the medical service. Hence, there is a need to provide data structures such as it is possible that the ordering instance for the medical service (i.e. a referring physician) which (who) also receives the result of the medical service may deliver evaluation data with respect to the quality of the received medical service.

Accordingly, the present invention is a computer implemented system and method for a central compensation of medical services. The platform comprises at least three actors:
A compensation unit. The compensation unit is adapted for processing and calculation of a reimbursement or financial equivalent for a medical service.
A referring computer. The referring computer is associated to a referring physician who orders a medical service. The medical service is typically not carried out by the referring physician himself but by another (external or internal) service computer which is in communication with the other actors.
A service computer. The service computer is a computer or a computer network of a service partner and is adapted for executing the medical service and for transmitting a result of the medical surface back to the referring computer or to an associated unit of the referring computer.

All the above-mentioned three actors interact over a computer network. The network might be the interne or an intranet or other local or wide area networks (LAN, WAN).

According to a main aspect of the present invention there is provided an improved mechanism for computer implemented compensation of the medical services rendered. Therefore, there is provided an additional data structure comprising an evaluation package. The evaluation package comprises evaluation information with respect to the medical service(s) rendered. The evaluation package might be provided in different formats, for example in an extended DICOM format with an additional field. This field may comprise coded data, wherein for example code “1” refers to “best quality”, code “2” refers to “middle level of quality” and code “3” refers to “bad quality”.

Alternatively, it is also possible to provide another data structure and a separate module for transmission of the evaluation package independently of the result of the medical service, i.e. independently of the medical report.

According to an aspect of the present invention the evaluation package is associated to the medical report. The medical report is the result of the medical service which is transferred from the service computer to the referring computer of the referring physician.

According to an aspect of the present invention the referring computer of the referring physician outputs an order for at least one medical service or several medical services. The service computer of the service partner receives this order and executes the medical service. Additionally, the service computer also generates and outputs a medical report as result of the medical service. The medical report is transferred from the service computer to the referring computer which receives the medical report and extends the same in order to attach the evaluation package in a generated specific data structure. The evaluation package comprises evaluation data. The evaluation data are normally generated by the referring computer of the referring physician and relate to (an evaluation of) the result of the medical service, i.e. the medical report. Alternatively, it is also possible that the evaluation data are generated by another instance or that several computer instances are provided for generating a part of the evaluation data which afterwards is combined to generate the evaluation package.

The compensation unit preferably is a computer-implemented sub-unit or a hardware and/or software module within an existing computer. It also might be a separate computer instance which is adapted for calculation and processing of compensation for medical services. The compensation unit receives the evaluation package with the evaluation data and processes the same in order to calculate an amount of compensation (which might be in form of monetary or non-monetary units, like points or an equivalent in spare time etc.) for the medical service(s) rendered.

According to an aspect of the present invention the above-mentioned three actors (compensation unit, referring computer, service computer) are separate computer instances which might be located at geographic different places and communicate over a computer network. Alternatively, it is also possible to combine these three actors in a central compensation unit which also combines the functionality of the three instances as mentioned above.

According to a further aspect, there are transmitted three different data structures between the three actors:

1. The order (from referring computer to service computer)
2. The medical report (from the service computer to referring computer) and
3. the evaluation package (from referring computer to compensation unit).

According to the actual application and implementation there might be chosen different formats for these data structures. Thus, it is possible to transmit the data in a DICOM (Digital Imaging and Communication in Medicine), in a JPEG format or in a PDF format or in any other formats fitting to the application.

According to another aspect, the evaluation data within the evaluation package is a specific data structure which comprises different data items. The definition of the data items might be adapted flexibly according to the actual application. Generally, the evaluation data are generated in order to access quality of the medical service(s). The items or criteria which might be selected to define the evaluation package all relate to an assessment of the medical service. They might be chosen out of the following list:
quality of the medical report, particularly quality of the image data;
comprehensiveness of the finding/report;
time interval between transmitting the order and transmitting the report (i.e. duration of the medical service);
correlation between the finding and a final diagnosis;
completeness of the examination (relating to the medical service) and
completeness according to pre-definable guidelines.

The above list is comprehensive but not exhaustive, so that also other items and conditions might be added. Further, it is also possible that another instance (besides the referring physician/computer) acts as evaluation instance and analysis and evaluates the medical report in order to generate evaluation data which then are combined to the evaluation package.

According to a still further aspect, the compensation unit comprises a computation unit. The computation unit might be integrated in the compensation unit or might be a separate computer unit which communicates over the network and is in data exchange with at least three actors. The computation unit is adapted to execute further data processing on the basis of the received evaluation package and relating to an assessment of a reimbursement of the medical service rendered. Further, the computation unit might comprise processing of statistical data or might comprise a transmission unit. The transmission unit is adapted for transmitting the result of the computation of compensation to other instances. Thus, it is possible to transmit the actual amount of compensation back to the service computer, which then—in turn—may generate an invoice on the basis of the received data.

According to another aspect, the compensation unit processes the evaluation data in order to calculate an amount for compensation of the medical service. Alternatively, the compensation unit may also provide for evaluation data for assessing quality of the medical service. Hence, the result of the processing of the computation unit might be the specific amount of compensation and additionally an evaluation report, comprising quality aspects of the medical service. Preferably, these evaluation data are provided in text form. However, any other format might also be chosen.

According to another aspect, calculated amount of compensation might be provided in different formats. Thus, it is possible to explicitly output a monetary unit as compensation. Alternatively or cumulatively it is possible to output other units, like counting points, time etc. (which subsequently might be taken into account for promotion).

According to another aspect, all processing with respect to the compensation might be facilitated by outsourcing the same to an external service provider.

A method, mentioned above might be implemented in software, in coded form and might be executed on different computers in a distributed environment. Alternatively, it is also possible to implement the invention in hardware and different hardware modules. The hardware modules are then adapted to perform the functionality of the method described above. Furthermore, it is possible to have a combination of hardware and software modules in order to implement the functionality described with respect to the method.

The present invention is defined by the claims and nothing in this section should be taken as a limitation on those claims. Further aspects, features and advantages of the invention are discussed below in conjunction with the preferred embodiments.

### BRIEF DESCRIPTION OF THE DRAWINGS

The figures illustrate the principles of the invention according to specific embodiments. Thus, it is also possible to implement the invention in other embodiments, so that these figures are only to be construed as examples. Moreover, in the figures, like reference numerals designate corresponding parts throughout the different drawings.

FIG. 1 is a schematic block diagram according to one embodiment of a computer implemented compensation system used within a medical system;

FIG. 2 is a flowchart diagram according to one embodiment of a method for compensating medical services.

### DETAILED DESCRIPTION OF INVENTION

Embodiments of a method for compensation for medical services taking into account an assessment of quality of the medical services are described hereinafter. One skilled in the art will recognize that the main principles of the invention can be practiced independently of a specific implementation (for example computer language C instead of Assembler and the like) all functionalities of the method according to the invention may be implemented in general purpose computers or in a distributed client-server-environment. Further, the invention may be practiced without one or more of the specific details, instances, modules, entities and method steps which are described hereinafter.

In the following there is given a short explanation of terms used in this description.

The term “compensation” is used generically herein and might thus refer to financial aspects in relation to a billing system, to a reimbursement strategy, to a strategy to defray the medical service etc. Moreover, the compensation may also refer to a general assessment of quality of the medical service rendered. Accordingly, a compensation might be provided in different units, like financial units (US$, Euro, etc.), in time units, in counting point units or in other quality assessment units.

The term “medical service” might refer to a specific singular service or to a plurality of services, so that the singular and the plural form are used interchangeably within this description. The medical service might be carried out by an external service provider or, alternatively, might be executed by an instance within a medical institution or hospital. Typically, the medical service is executed on a service computer, which for example might be a computer within a radiology department in order to generate radiological images or might be a computer of a laboratory, in order to generate laboratory examinations etc. Typically, the method is applied for medical services rendered for a patient within a distributed medical environment (for example hospital, network of medical practitioners or clinical instances etc.). All entities of the network are computer implemented and communicate over a computer network, which might be the internet or an intranet (for example a hospital internal intranet) such as a local area network (LAN) or a wide area network (WAN) or alternate types of network. Moreover, anyone of a variety of client-server architectures may be used, including but not limited TCP/IP (HTTP network) or specifications like DICOM networks. All modules, entities and units of the system (clients and servers) may be interconnected by a bus, like an enterprise service bus (ESB). Further, there might be used a central or several databases and databanks for storing and retrieving data related to the implementation of the method according to the invention. Thus, the network may include a plurality of devices, such as servers, routers and switching circuits connecting in a network configuration, as known by a person skilled in the art.

The system according to the invention comprises at least two actors: a compensation unit within a referring computer and a service computer. Alternatively, it is also possible to provide the compensation unit not within the referring computer but another third separate computer. All these computers may be general purpose computer or specific computers. The computer device may for example be a personal computer (PC), a personal digital assistant (PDA) or other devices using wireless or wired communication protocols to access the other network modules and servers. The computers might be coupled to input/output devices (not shown in the Figures) that may include a keyboard in combination with a pointing device, such as a mouse to input data into the computer, a computer display screen and/or a printer to produce the output (computation of compensation) in paper form, a storage resource, such as a database or repository or hard disk drives for storing and retrieving data for the different computers. All computers may access separate databases or might access a central unitary database. Moreover, it is possible to outsource specific functionalities of the method and system according to the invention to external devices for load efficiency reasons. For example the compensation unit might be associated to one or several further units. The further units might be adapted to specific data processing, like encryption and decryption of data, to transmitting data to other instances and entities, to automatically retrieving data or to redundant servers for both faster operations and enhanced reliability etc.

The term “evaluation data” is to be construed generically and relates to data with respect to an evaluation or analysis of the medical services rendered. Normally, the evaluation data is generated by the referring physician at the referring computer. In another embodiment, it is possible that also other instances are used for evaluating the medical report, so that also this data are combined with the referring physician's data in order to generate an evaluation package. The evaluation package is a specifically generated data structure which is transmitted from the referring computer to the compensation unit. Preferably, the evaluation package has a two-part structure: the medical report as a first element and evaluation data as a second element. The evaluation data might be provided in different formats, like text format, graphic format etc.

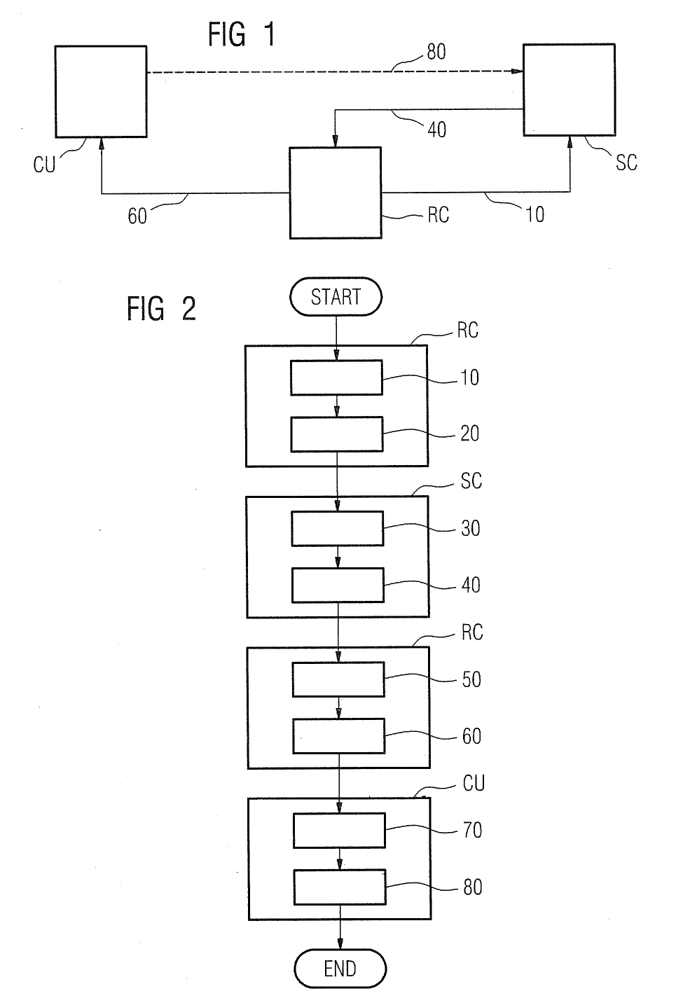

FIG. 1 shows a schematic diagram of three actors: a referring computer RC of the referring physician, a service computer SC of a service partner and a compensation unit CU which is adapted for calculation of compensation for medical services rendered by the service computer SC. In FIG. 1 the network or the bus system is not explicitly depicted. However, the data exchange between these three actors is described in more detail below.

With respect to FIG. 2 there is given a description of an example according to one embodiment of the invention in which sequence steps of the method might be carried out.

For example if a patient sees a doctor for his leg causing pain, the doctor further examines the patient's leg and may have the assumption of a fracture of the leg. Therefore, he orders an additional medical service in order to validate his diagnosis. The doctor for example may order a radiological examination of the leg.

After the referring physician has decided for execution of a medical service he inputs an order for execution of the medical service at his referring computer RC. After the referring the computer RC has received these input signals the order for the medical service is generated in step 10. The order is preferably generated automatically. Afterwards, the order is automatically transmitted to the service computer SC of the service partner in step 20.

After receiving the order at the service computer SC the order is executed. This is normally done by an examination of the patient. Afterwards, a medical report is generated by the service partner. The medical report typically comprises medical images (in case the medical service relates to the acquisition of images) and a finding or diagnosis in text form. The execution of the order and the generation of the medical report are done in step 30. Afterwards, the medical report is transmitted in step 40 to the referring computer RC. After receiving the medical report at the referring computer RC the medical report is evaluated by the referring computer RC. Alternatively, the medical report might also be analyzed by other instances in order to generate an assessment of quality of the medical service rendered by the service computer SC. All evaluation and assessment data are collected and combined in an evaluation package in step 50. Afterwards, the evaluation package is transmitted to the compensation unit in step 60. Afterwards, the compensation unit CU calculates the amount of compensation in step 70. It is also possible to extend data processing in step 70 in order to provide further assessing functionalities.

In FIG. 2 there is depicted a last step, designated with reference numeral 80. This step refers to the transmission of compensation data for accounting and/or for bench marking or for other functionalities to other actors. However, it is also possible to implement the invention without this last step 80 so that the result of the compensation is not transmitted to other actors but is only outputted at the compensation unit CU.

According to a specific embodiment which is depicted in FIG. 1, the result of the compensation, the compensation data, are transmitted back the service computer SC. However, as already mentioned above, this transmission is not mandatory. Therefore, the transmission functionality, depicted with reference numeral 80 in FIG. 1 is only printed as dashed line in order to show that this transmission is only an example.

According to another embodiment of the invention, there is not provided a separate compensation unit CU. The functionality of a compensation unit CU is integrated within the referring computer RC of the referring physician or to associated computers.

In this context it has to be pointed out repeatedly that it is possible to integrate the compensation unit CU and the referring computer RC in one module/computer. Preferably this module/computer will be the referring computer RC of the referring physician. In this case the invention is only based on two separate actors, namely the service computer SC and the referring computer RC, which also comprises the compensation unit CU as integrated module. The medical service may be an ambulatory or a stationary service, for example a radiological service.

For example, possible orders could be:

to generate images by means of different modalities (ultrasound, PET, CT, MR etc.)

to execute laboratory examinations (for example blood exams etc.)

to generate anamnesis data and/or

to see a medical specialist etc.

However, this list is not construed as being exhaustive.

Referring again to the FIGS. 1 and 2 a possible example for the invention is to be seen in the following example, mentioned above. A patient sees a doctor because of his leg pain. The doctor examines the patient's leg and generates the assumption that the leg has a fracture. In order to validate his diagnosis, the doctor generates an order (step 10), which is transmitted to the radiological department of the hospital (step 20). After taking the radiological image of the patient's leg the medical report is generated in step 30 and transmitted back to the physician (step 40). After receiving the medical report the doctor will validate or not his assumption about the broken leg and will select a proper treatment for the patient. In this respect it has to be pointed out that the proper selection of the treatment is not subject-matter of the present invention. In contrast, the present invention mainly refers to the evaluation of the received medical report (step 50). Therefore the physician evaluates the received medical report taking into account the quality of the report, the time for carrying out the medical service, the quality of the images, the completeness of the examination, for example in case the order was directed to a sequence of several examinations or to other evaluation criteria, which may be pre-definable. Preferably, the evaluation is facilitated by means of a user interface which is provided on a browser or a screen. Specifically, a menu (for example in list formed) is generated on the user interface, on which the user (here the referring physician) may selected several items for examples via mouse or other input elements. For example it is possible that the physician may select between following items: “image quality optimal”, “image quality normal/average”, “image quality not acceptable”. The granularity of the items to be chosen by the user is pre-definable. Also a finer graduation may be selected (for example relating to more than 3 items).

According to a preferred embodiment the user interface for inputting the evaluation data is generated automatically.

In a preparation phase it is possible to define several parameters and adjustments or criteria on which the evaluation should be based on. For example the evaluation criteria could refer to image quality (as already mentioned above) to comprehensiveness of the medical report or the finding; according to time related aspects and completeness aspects. All input data relating to these criteria are acquired via the user interface from the referring physician. After the evaluation data have been inputted completely by the physician it is possible to forward these data to a further processing unit. The processing unit (not depicted in the figures) may be adapted to process the evaluation data in order to generate a result in form of an evaluation package which then is transmitted to a computation unit. The computation unit CU processes the received evaluation data automatically. Here again, it is possible that in a preparation phase there can be defined criteria according to which the compensation has to be calculated. For example it is possible to define categories of compensation, so that in case the evaluation data is “optimal quality” then the compensation is selected as “highest compensation”. In case the evaluation data is “minor quality” then a “lower most compensation” might be chosen.

According to another aspect of the invention it is possible to generate messages relating to the processing of the evaluation data. For example in case it turns out that the compensation has been calculated to be the lowermost or the uppermost, then a respective message could be send as a feedback message to one of the three actors or to additional instances in order to inform the service computer SC about the good/bad quality or to inform the referring physician about the good/bad quality of the service rendered.

According to another aspect it is possible to forward the compensation data to another instance in order to provide a secure data exchange. For example the compensation data or other data to be protected from unauthorized access could be made anonymous or could be transmitted encrypted form.

According to another aspect of the invention the evaluation data are detected automatically and not via a user interface, as mentioned above. In this embodiment, in the preparation phase there are to be defined parameters of the medical report which have to be analyzed. Further, there are to be defined criteria according to which acquired values, relating to the parameters have to be evaluated in order to automatically generate evaluation data. For example image data could automatically be analyzed whether or not they comprise artefacts. Another criteria could be if image resolution of the images in the medical report is OK nor not. Another criteria, which is detected automatically is the length of the medical report. Here again, in the preparation phase it could be defined, that the medical report should at least comprise a length of xyz. In case this length is met, the quality is OK, otherwise the quality is missed. In this respect it has to be pointed out that the evaluation is done fully automatically and without any user interaction. The skilled person in the art will recognize, however, that it is also possible to combine the fully automated detection of evaluation data with a manual detection of evaluation data, inputted by the ordering physician. Furthermore, it is also possible to provide a separate and independent evaluation unit, which is not the service computer SC and not the referring computer RC but a separate evaluation instance.

According to a preferred embodiment the compensation unit will be a computer system, associated to a reimbursement system for medical services, like an insurance system. In the past the insurance system had to refund or repay a fixed amount for medical services, rendered by the service partner without any evaluation of the quality. In contrast to these prior art systems the invention allows for a cost compensation which takes into account the quality of the service rendered. Generally, there are two ways the invention could be implemented:
1. The compensation unit, for example the insurance system, may actively request evaluation data for calculating the exact amount of compensation or
2. the compensation unit/insurance service will be automatically provided with evaluation data.

The above-mentioned two possibilities refer to a POP/PUSH-procedure, known from in telecommunication systems.

According to the invention in contrast to prior art systems it is possible to calculate the amount of compensation in dependence of the fact if the referring physician has actually received the medical report for the medical service ordered by him. In the past there have been cases in which the insurance system also refunded costs for medical services, which have been ordered by a referring physician but which never have been received by him (for example because the examination could not be executed completely or because of a failure of transmission between the service computer and the referring computer etc.). According to the invention it is automatically detected if the medical report has been received by the ordering instance (the referring physician) or not. In case the medical report has not been received, a flag is set in the evaluation data which will be taken into account by assessing the compensation.

According to another aspect the present invention is implemented as an additional module into an existing hospital information system (HIS). Further, the evaluation data and/or the compensation data might be forwarded to a radiological information system (RIS) for informing about quality of the services rendered.

It has to be pointed out that the criteria for assessing the quality of the medical services made be adapted flexibly according to the specific application. It is also possible to add further criteria or parameters for assessing the quality, while already using the system.

Embodiments within the scope of the present invention also include computer-readable media for carrying or having computer-executable instructions or data structures stored thereon in order to execute the method according to the invention. Such computer-readable media can comprise random access memory (RAM), read only memory (ROM), electrically erasable programmable read only memory (EEPROM), or media-like CD-ROM or other optical disc storage, magnetic disc storage or other storage devices used to carry and store the program and/or data structures according to the invention.

One skilled in the art will recognize that the computers or actors used for the invention, like the compensation unit CU, the referring computer RC and the service computer SC may be a specific or a general purpose computer. In the latter case the computer include a processing unit, a system memory, a system bus that couples various system components. Further, there is provided a basic input/output system (BIOS) and several drivers or other computer components, like interfaces and peripheral devices.

The scope of the invention is, therefore, indicated by the appended claims rather than by this description. All changes which come within the meaning and range of equivalency of the claims are to be embraced within their scope.

What is claimed is:

1. A computer implemented method for calculating a compensation of a medical service, comprising:
ordering a service computer of a service partner to execute the medical service by a referring computer of a referring physician;
executing the medical service by the service computer;
transmitting a medical report of the medical service to the referring computer;
generating an evaluation package to extend the medical report with additional evaluation data;
transmitting the evaluation package to a compensation unit; and
calculating the compensation of the medical service by the compensation unit.

2. The method according to claim 1, wherein the compensation unit and the referring computer are integrated in one unit.

3. The method according to claim 1, wherein the order, the medical report and/or the evaluation package is provided in a format comprising DICOM, JPG, or PDF.

4. The method according to claim 1, further comprising evaluating assess quality of the medical service by the referring computer.

5. The method according to claim 1, wherein the evaluation package is generated by the referring computer.

6. The method according to claim 1, wherein the evaluation package is transmitted to the compensation unit by the referring computer.

7. The method according to claim 1, further comprising transmitting a compensation order from the compensation unit to the service computer or vice versa.

8. The method according to claim 1, wherein a plurality of medical services are accumulated to be compensated with one compensation process.

9. The method according to claim 1, wherein the computation unit executes further data processing based on the evaluation package.

10. The method according to claim 9, wherein the further data processing comprises to calculate an amount of the compensation, to evaluate parameters, or to carry out statistical data processing.

11. The method according to claim 1, wherein the compensation is calculated by considering the evaluation package for assessing quality of the medical service.

12. The method according to claim 1, wherein the medical service is an ambulatory or stationary radiological service.

13. The method according to claim 1, wherein the evaluation package is generated by processing a pre-definable criteria that is selected from the group consisting of: quality of the medical report, comprehensiveness of the medical report or a finding, time interval between transmitting the order and transmitting the medical report, correlation between the finding and a final diagnosis, completeness of the medical service, and completeness of the medical service according to guidelines.

14. The method according to claim 1, wherein the order, the report, the evaluation package and the compensation are transmitted encrypted and made anonymous.

15. The method according to claim 1, wherein at least one of the compensation unit, the service computer, and the referring computer exchanges data with an additional unit coupled via an interface.

16. The method according to claim 1, wherein the evaluation package is detected automatically or inputted manually by a user interface of the referring computer.

17. The method according to claim 1, wherein the compensation unit, the service computer, and the referring computer are communicated over a computer network.

18. An apparatus used in a computer network for calculating a compensation of a medical service, comprising:
a compensation unit that is adapted to calculate the compensation of the medical service;
a referring computer of a referring physician comprising:
an ordering unit that is adapted to request a service partner to execute the medical service,
a reception unit that is adapted to receive a medical report of the medical service from the service partner,
an evaluation unit that is adapted to generate an evaluation package by extending the medical report with additional evaluation data, and
a transmission unit that is adapted to transmit the evaluation package to the compensation unit for calculating the compensation; and
a service computer of the service partner that is adapted to execute the medical service and to transmit the medical report of the medical service to the referring computer.

19. The apparatus according to claim 18, wherein the compensation unit, the service computer, and the referring computer are communicated over the computer network.
